(19) United States
(12) Patent Application Publication
(10) Pub. No.: US 2026/0267125 A1
(43) Pub. Date: Sep. 10, 2026

(54) REFLECTION-BASED PHASE CONTRAST MICROSCOPE SYSTEM

(71) Applicant: Applied Materials Israel Ltd., Rehovot (IL)

(72) Inventors: Amir SHOHAM, Haifa (IL); Ilan Matan HURWITZ, Rishon LeZion (IL)

(21) Appl. No.: 19/072,867

(22) Filed: Mar. 6, 2025

(51) Int. Cl. G02B 21/14; G02B 5/30; G02B 21/00

(52) U.S. Cl. CPC G02B 21/14; G02B 5/3083; G02B 21/0056

(57) ABSTRACT

A reflective phase contrast microscope system, and a corresponding inspection system are described. The phase contrast microscope comprises an illumination channel, a collection channel, a space variant beam splitting unit and an objective lens arrangement. The space variant beam splitting unit comprises a pattern of transmitting regions and at least one partly reflecting region. Wherein the partly reflecting regions have a form that, when reflecting light toward the objective lens or coming from the objective lens, the reflected light pattern forms a ring illumination pattern.

### TECHNOLOGICAL FIELD

The present disclosure relates to phase contrast microscope systems and methods, and in particular to reflection-based phase contrast microscope systems.

### BACKGROUND

Phase contrast microscopy is an optical microscopy technique converting phase variation in light passing through a sample into amplitude or intensity variation in an image formed by a microscope system. The general technique was invented by Zernike in 1935 and allowed several scientific breakthroughs allowing non-destructive imaging of biological materials. The conventional phase contrast microscopy typically uses a transmission-based optical arrangement, which is suitable for substantially optically transparent samples.

Reflection based phase contrast microscopy provides for visualization of phase variations or surface details in a sample. This technique can be used for opaque or reflective samples and is not limited to optically transparent samples.

### GENERAL DESCRIPTION

Reflection-based phase contrast microscopy enables imaging of samples while converting phase variations in the collected light to amplitude or intensity variations in the resulting image. This technique enables visualization of surface pattern, material variations and other phase variations is samples, and is useful for samples that are not necessarily highly optically transparent. A standard phase contrast microscope system typically utilizes three main elements for affecting the illumination and collection pattern to convert phase variations to contrast data within the resulting image. Such elements typically include a condenser having an annulus, or ring-shaped aperture, a beam splitter for separating between illumination and collection paths, and a collection aperture carrying a pattern of attenuation and phase shifting regions.

The present disclosure provides a reflective phase contrast microscope system that utilizes a space variant beam splitting unit, integrating an illumination channel, a collection channel, an objective lens arrangement. The space variant beam splitting unit features a pattern of transmitting regions and partly reflecting regions, designed to generate a ring illumination pattern by reflecting light toward or from the objective lens. These partly reflecting regions may include elliptic segments and exhibit a reflection-transmission ratio ranging from 1.5/8.5 to 4/6.

The collection channel incorporates phase plates with ring-shaped phase-affecting regions for altering the phase of light corresponding to the ring illumination pattern. Additionally, the system may utilize a variable phase affecting unit enables dynamic tuning of phase using polarization-dependent phase elements, such as birefringent materials, and a polarization analyzer to selectively control phase and attenuation. A polarization correction module offers continuous variation in phase and attenuation for specific spatial regions via rotatable optical elements with annular active regions.

In some configurations, the phase contrast microscope may be designed for applications such as scanning microscopy. In such configurations, the system may include annular phase plates in the illumination channel and annular collection apertures in the collection channel. It can also function as part of an inspection system, accommodating samples on a mount and utilizing the described components to produce high-contrast imaging.

Thus, according to a broad aspect, the present disclosure provides a reflective phase contrast microscope system comprising an illumination channel, a collection channel, a space variant beam splitting unit and an objective lens arrangement; the space variant beam splitting unit comprises a pattern of transmitting regions and at least one partly reflecting region;
wherein the partly reflecting regions have a form that, when reflecting light toward the objective lens or coming from the objective lens, the reflected light pattern forms a ring illumination pattern.

According to some embodiments, the partly reflecting regions comprise at least one elliptic segment configured to reflect light toward the objective lens, forming a ring-shaped illumination pattern directed at the objective lens.

According to some embodiments, the partly reflecting region has a reflection transmission ratio in a range between 1.5/8.5 and 4/6.

According to some embodiments, the collection channel comprises at least one phase plate configured to apply a selected phase variation to light passing therethrough.

According to some embodiments, the at least one phase plate comprises a ring-shaped phase affecting region surrounded by transmitting regions, the ring-shaped phase affecting region has geometry and for affecting phase of light associated with the ring illumination pattern.

According to some embodiments, the collection channel comprises a variable phase affecting unit operable for selectively tunning phase of light components associated with the ring illumination pattern.

According to some embodiments, the variable phase affecting unit comprises two or more controllable polarization dependent phase affecting elements having a ring-shaped phase affecting region surrounded by transmitting regions, and at least one polarization analyzer.

According to some embodiments, the two or more controllable polarization dependent phase affecting elements are formed of birefringent materials having a fast axis and a slow axis both perpendicular to direction of transmission of light through the material.

According to some embodiments, the reflective phase contrast microscope system may further comprise a polarization correction module configured and operable to provide continuously varying phase and attenuation variation to a selected spatial region of the collection light.

According to some embodiments, the polarization correction module comprises two or more polarization dependent rotatable phase affecting optical elements, and a polarization analyzer, rotation angle of the phase affecting optical elements provides a selected phase shift and a selected polarization orientation to light components passing through an active phase affecting region of the phase affecting optical elements, the polarization analyzer attenuates output light in accordance with the polarization orientation thereof.

According to some embodiments, the active phase affecting region of the phase affecting optical elements has an annular shape, being aligned with annular structure of an illumination beam illuminating the sample.

According to some embodiments, the eflective phase contrast microscope system may be configured for use as a scanning microscope, wherein the illumination channel comprises an annular phase plate and the collection channel comprises an annular collection aperture.

According to one other broad aspect, the present disclosure provides an inspection system comprising a reflective phase contrast microscope system and a sample mount; the reflective phase contrast microscope system comprising an illumination channel, a collection channel, a space variant beam splitting unit and an objective lens arrangement, and is configured for imaging one or more samples positioned on the sample mount;
wherein the space variant beam splitting unit comprises a pattern of transmitting regions and at least one partly reflecting region;
wherein the partly reflecting regions have a form that, when reflecting light toward the objective lens or coming from the objective lens, the reflected light pattern forms a ring illumination pattern.

The inspection system may be configured in accordance with any embodiment described herein in connection with the reflective phase contrast microscope system.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a conventional reflective phase contrast microscope system;

FIG. 2 illustrates a reflective phase contrast microscope according to some embodiments of the present disclosure;

FIG. 3 exemplifies a space variant beam splitter according to some embodiments of the present disclosure;

FIG. 4 exemplifies an additional configuration of a space variant beam splitter according to some embodiments of the present disclosure;

FIG. 5 illustrates reflective a reflective phase contrast microscope utilizing continuous phase control according to some embodiments of the present disclosure;

FIG. 6 illustrates a reflective phase contrast microscope utilizing polarization and magnification control according to some embodiments of the present disclosure; and

FIG. 7 illustrates another configuration of the reflective phase contrast microscope utilizing a polarization correction module configured to affect both attenuation and phase shift of light components.

### DETAILED DESCRIPTION OF EMBODIMENTS

As indicated above, phase contrast microscopy is an imaging techniques directed at generating contrast and amplitude variation resulting from phase variation of light interacting with a sample. The use of phase contrast microscopes enables imaging of elements including regions having material differences, while being optically transparent, allowing e.g., imaging of living cells and microorganisms without damaging them.

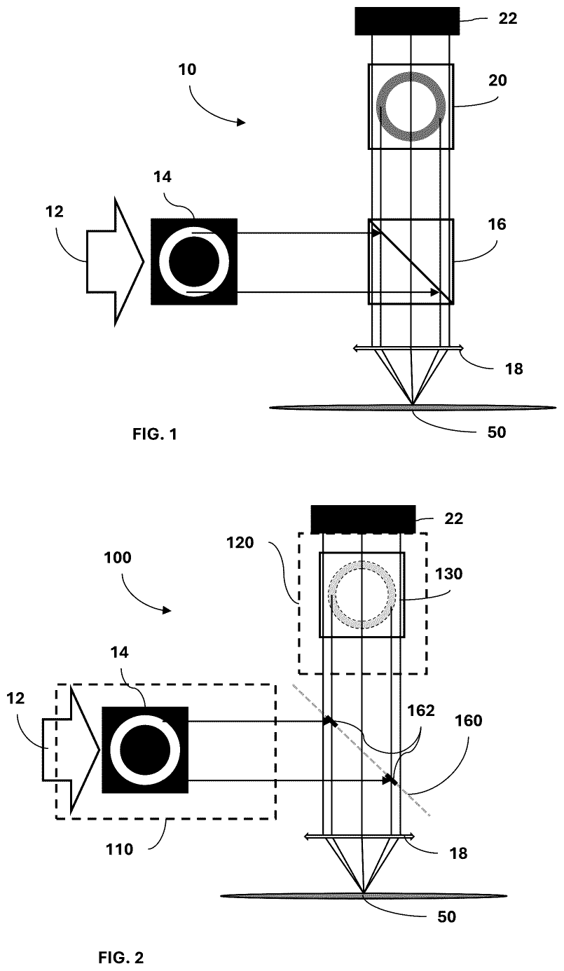

In this connection, FIG. 1 illustrates a reflective based phase contrast microscope 10 configured in accordance with the conventional art. Phase contrast microscope 10 is configured to receive input illumination 12 through an annular aperture 14 generating an annular illumination beam. A beam splitter 16 is generally used to direct the illumination toward a lens 18, typically being an objective lens, which focuses the illumination onto a sample 50. The lens 18 also collects light reflected and scattered from the sample 50, and the collected light, formed of reflected and scattered light components, is transmitted through the beam splitter 16 toward the collection path. The collection path includes at least phase and amplitude mask 20 having an annular attenuation region surrounded by phase affecting region, and further optics 22 including e.g., an eyepiece, imaging arrangement, detector, etc.

The phase contrast microscope 10 exemplified in FIG. 1, generally utilizes similar optical elements as in a conventional transmission-based phase contrast microscope, manipulated to provide illumination and collection from a common side of the sample 50. This configuration enables imaging and inspection of non-transmissive samples, providing visualization of phase variation in the form of amplitude and contrast variation. More specifically, annular aperture 14 is configured to provide annular illumination pattern, which, when focused onto the sample 50 by the objective lens 18, provides illumination that arrives from a selected angular range. Further, phase and amplitude mask 20 includes an annular attenuation region is aligned with annular region of annular aperture 14 to reduce intensity of light components associated with specular reflection of the illumination. The phase affecting region surrounding the annular attenuation region of mask 20 provides a selected phase shift to light components scattered from the sample 50.

While enabling imaging of phase variation based on reflective microscopy, the reflective based phase contrast microscope 10 exemplified in FIG. 1 typically suffers from a reduced signal due to high losses. This is in partly associated with loss of about 50% of illumination intensity, and further about 50% of collection intensity, leading to potential collection of no more than 25% of the light downstream of beam splitter 16. In addition to loss due to the use of the beam splitter 16, the collection path utilizes a mask 20 including an attenuation region, typically allowing transmission of about 30% of light intensity passing through the region. As a result, the conventional reflective based phase contrast microscope experiences a typical optical transmission of around 7.5%.

To provide reflective based phase contrast microscopy, while enhancing the collected signal, the present disclosure utilizes a space variant beam splitting unit providing selected illumination pattern and directing light between the illumination channel and the collection channel, while reducing loss of illumination radiation. FIG. 2 exemplifies a reflective-based phase contrast microscope system 100 according to some embodiments of the present disclosure. The reflective based phase contrast microscope system includes an illumination channel 110, a collection channel 120, a space variant beam splitting unit 160 and an objective lens arrangement 18. The illumination channel 110 is configured to receive input illumination 12 and to direct the input illumination onto the space variant beam splitting unit 160. Illumination channel 110 may include an annular aperture 14 providing an annular illumination pattern as exemplified in FIG. 2. In some embodiments, the space variant beam splitting unit 160 may provide patterning of the illumination beam to provide annular illumination pattern as described in more detail below.

The collection channel 120 is configures to collect light reflected from the sample 50 and direct the collected light for collection, e.g., utilizing one or more optical elements 22 being an eye piece, imaging arrangement, detector, etc. the collection channel 120 may include a collection aperture plate 130 configured to provide a selected phase shift to one or more regions of the collected beam.

The space variant beam splitting unit 160 is formed of a plate having a pattern of transmitting regions and at least one partly reflecting region 162. The partly reflective region 162 has a form providing collection of the input annular beam pattern and reflecting the annular beam pattern toward the sample 50, while maintaining its annular spatial pattern. For example, for perpendicular arrangement of the illumination 110 and collection 120 channels, the space variant beam splitting unit 160 may be positioned at an angle of 45 degrees with respect to direction of input illumination and direction of collection of illumination. In such configuration, the partly reflecting region 162 may be formed with a generally elliptic shape. The partly reflective region 162 is surrounded by transmitting regions.

Generally, the locations of the optical elements in the exemplary configuration of FIG. 2 and in any other configuration exemplified below may be determined in accordance with optical design of the system. For example, the annular aperture 14 may typically be placed at a back focal plane (Fourier plane) with respect to the objective lens 18. Additionally, the collection aperture plate 130 may be placed at a first plane (Fourier plane) with respect to the objective lens 18.

It should be noted that the reflective-based phase contrast microscope system 100 according to various embodiments of the present disclosure may be used in field microscopy application using the configuration described above. Additionally, in some embodiments, the reflective-based phase contrast microscope system 100 may be used for scanning microscopy applications. In such applications, a direction of light passage through the reflective-based phase contrast microscope system 100 may be reversed. More specifically, the collection channel 130 may be used for providing an illumination beam, where the collection aperture plate 130 provides a selected phase shift between light components of an annular region of the input beam and surrounding light components. Further, in this configuration, the illumination channel 120 is used for collection of light returning from the sample 50, collecting the output light through annular aperture 14 to provide output data on reflection from the inspected location of the sample. This configuration may be used for scanning a sample point-by-point and for each point providing an output signal, indicative on a phase of light returning from this point, enabling to provide a phase map of the sample.

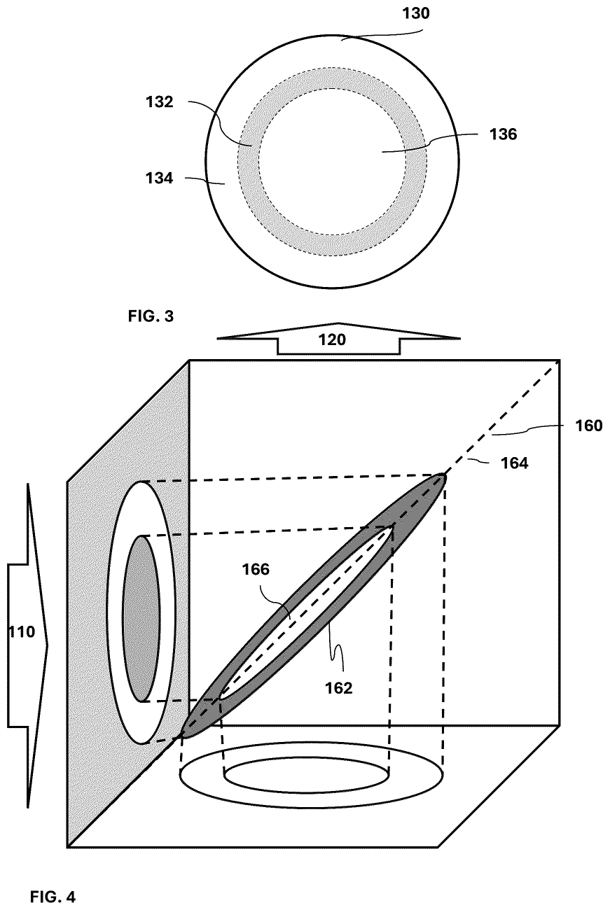

Further, reference is made to FIGS. 3 and 4 exemplifying the collection aperture plate 130 and space variant beam splitting unit 160 respectively. The collection aperture plate 130 includes transmitting regions 134 and 136 and annular phase affecting region 132 configured to apply a selected phase shift to light components transmitted therethrough. In some embodiments, regions 134 and 136 may be phase affecting and region 132 may be a transmitting region. The configuration of collection aperture plate 130 is selected to apply selected phase variation between specular reflection light components and scattered light components, in accordance with the design of the phase contrast microscope. Generally, the phase variation between regions 134 and 136 with respect to region 132 may be associated with typical phase shift applied in the conventional phase contrast microscope systems, while avoiding amplitude attenuation.

The space variant beam splitting unit 160 is exemplified in FIG. 4. Typically, the space variant beam splitting unit 160 may be formed of a plate having a partly reflective region 162 and transmitting regions 164 and 166. The plate may be positioned at a selected angle, e.g., 45 degrees, and configured to receive input illumination coming from the illumination channel 110 and direct the input illumination toward the sample, while maintaining the annular illumination pattern.

The partly reflective region 162 may be configured by a selected coating level of the plate material, to provide reflection about a selected portion of input illumination. For example, the partly reflective region 162 may be configured to reflect 50%, or 40% or 30% of light impinging thereon. Similarly, the partly reflective region may be configured to transmit 50% or 60% or 70% of light impinging thereon. The use of the partly reflective region 162 of the space variant beam splitting unit 160 enables to provide selected attenuation to the specular reflection light components, and thus to reduce loss of signal intensity. For example, for a partly reflective region 162 having reflectance R and transmittance (1-R), the total signal may be about R·(1-R), for or R=50% this may be R·(1-R)=25%, for R=30% the signal may be R·(1-R)=21%. Transmitting regions 164 and 166 of the space variant beam splitting unit 160 have almost 100% transmission light components scattered from the sample, further enhancing the collectable signal as compared to the conventional techniques.

As indicated above, the space variant beam splitting unit 160 utilizes a partly reflective region 162 and transmitting regions 162 and 166 having spatial structure selected to maintain a structure of an annular illumination pattern and direct the illumination toward the objective lens 18 and the sample 50. Accordingly, the partly reflective region 162 may be formed with an elliptic shape selected in accordance with the angle of orientation of the space variant beam splitting unit 160 as exemplified in FIG. 4.

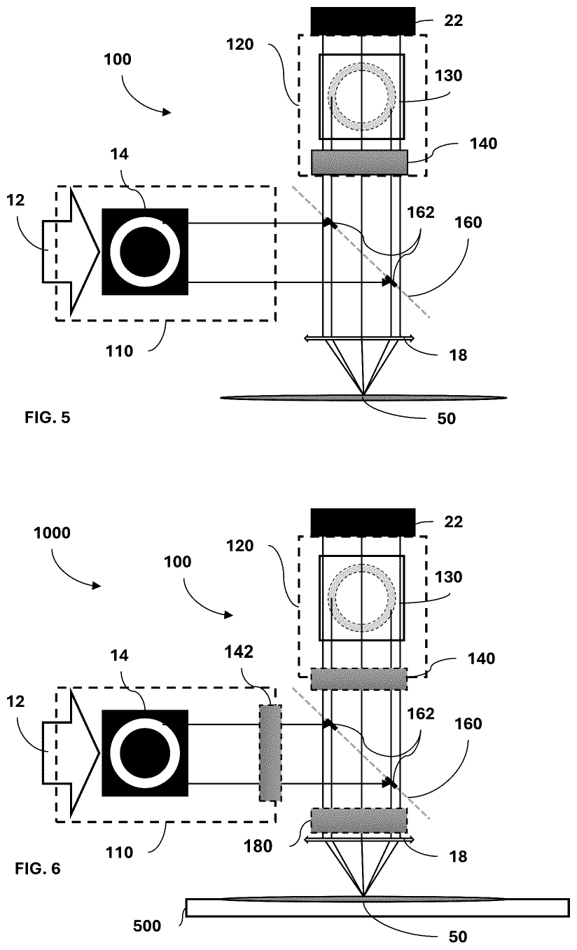

The reflective based phase contrast microscope system 100 of the present disclosure may utilize one or more additional optical elements, enabling selected manipulation of the illumination and/or collection path to increase signal intensity. FIG. 5 exemplifies a selected and not limiting configuration of the reflective based phase contrast microscope system according to embodiments of the present disclosure. FIG. 5 exemplifies a reflective based phase contrast microscope system 100 utilizing a polarization correction module 140 positioned in the collection channel 120 and configured to provide selected polarization and/or phase corrections to the collected light.

The polarization correction module 140 may be configured to apply selected correction of either one of polarization of light or phase shift and/or intensity of a selected polarization component. Polarization correction module 140 may include an annular correction region configured to apply the selected correction to light components within a ring-shaped beam section, while allowing light components outside of the ring shape portion to be transmitted without changes.

Generally, the reflective based phase contrast microscope 100 of the present disclosure may be used for various microscopy applications including imaging of biological samples etc. In some embodiments, the reflective based phase contrast microscope system 100 may be sued for inspection of selected samples including e.g. semiconductor wafers and/or reticles, or any other type of samples including e.g. biological samples. Inspection of relatively large samples such as wafer and/or reticle typically requires scanning of the sample region and may also require control of optical properties such as polarization, magnification and focusing level of the illumination beam. Accordingly, the reflective based phase contrast microscope system may be used in combination with selected additional elements including a sample mount 500 and selected optical elements. For example, FIG. 6 exemplifies an inspection system 1000 including a reflective based phase contrast microscope system 100 and a sample mount 500 configured for holding a sample 50 and enabling selected translation of the sample within an inspection plane, and optionally adjustment of sample height. The inspection system may also include or be associated with a controller (not specifically shown) configured for operating the phase contrast microscope 100 and sample mount 500 and for receiving and processing inspection data. The reflective based phase contrast microscope system 100 of FIG. 6 is generally similar to the example of FIGS. 2 and 5, while including one or more additional optical elements 140, 142 and 180 positioned along the illumination channel 110, collection channel 120 and sample path. More specifically, the reflective based phase contrast microscope system 100 may include an optical magnification/focusing module 180 positioned in path of light directed toward and collected from the sample 50. The optical magnification/focusing module 180 may include one or more optical elements such as one or more lenses, relay arrangement, telescope arrangement, etc., operable and configured to enable selected properties of illumination and collection of light from the sample 50. Magnification/focusing module 180 may be used to enable a selected size of illumination spot on the sample, and may enable selective variation of illumination spot size, focusing distance or other optical properties needed for proper inspection of the sample.

In addition to control over focusing and size of an illumination spot, optical elements 140 and 142 may be used to provide control over polarization of light directed at the sample and collected from the sample. For example, the illumination channel 110 may include a polarization filter 142 positioned in a selected orientation, and the collection channel 120 may include an additional polarization filter 140, being a full or partial polarization filter (as exemplified in FIG. 5). Optical elements 140 and 142 may also be formed of retarder plates, such as half-or quarter-waveplates, and/or liquid crystal arrangement positioned and configured to provide selected modulation of light components having one or more polarization orientations.

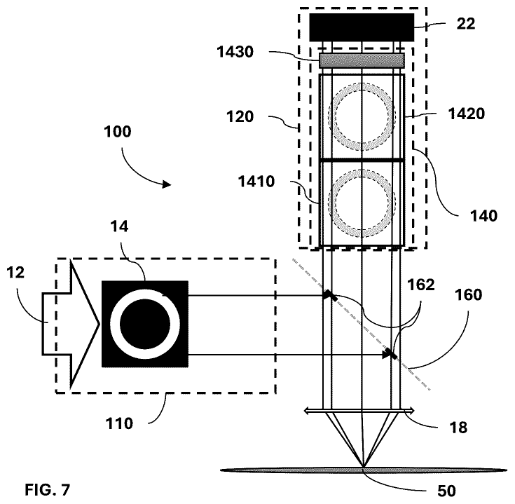

Further, reference is made to FIG. 7 exemplifying an additional configuration of the reflective based phase contrast microscope system 100. In this exemplary configuration, the collection aperture plate 130 is merged with the polarization correction module 140. The polarization correction module 140 is configured to affect both attenuation and phase shift of light components passing through an annular region thereof. The polarization correction module 140 includes a first and a second rotatable polarization dependent phase affecting elements 1410 and 1420 and a polarization analyzer 1430. The polarization dependent phase affecting elements 1410 and 1420 are formed with a phase affecting annular region, optically aligned with annular aperture 14, surrounded by transparent regions. The phase affecting annular regions of the polarization dependent phase affecting elements 1410 and 1420 may be formed of birefringent materials, and/or liquid crystal arrangement, and configured to apply a phase shift between orthogonal polarization components of light passing therethrough.

In a specific example, phase affecting region of the first polarization dependent phase affecting elements 1410 may be a half wavelength plate (or a quarter wavelength plate), and phase affecting region of the second polarization dependent phase affecting elements 1420 may be a quarter wavelength plate (or a half wavelength plate), and polarization analyzer 1430 may be a linear polarization filter. Rotation of the first and second polarization dependent phase affecting elements 1410 and 1420 enables selective adjustment of phase shift and attenuation of light components of the annular region with respect to surrounding light components. The use of the polarization correction module 140 enables operation of the reflective based phase contrast microscope system 100 with various phase shift and attenuation levels and selected a suitable phase shift and attenuation level providing optimal or maximal signal to noise ratio. For example, phase shift and attenuation level may be selected to maximize/optimize signal to noise ratio in operation of the reflective based phase contrast microscope system 100.

Generally, as indicated above, the reflective based phase contrast microscope system 100 may also be used in reverse operation direction. More specifically, the collection channel 130 may be used as illumination channel, and the illumination channel 120 may be used for collection. Accordingly, input illumination is transmitted through polarization correction module 140, providing polarized illumination having a selected attenuation and a selected phase shift to light components of an annular region of the input light. Further, the light reflected from sample 50 may be collected via annular aperture 14 for collection of output data. This configuration is suitable for use in scanning microscopy applications, and may generally utilize a reversed arrangement of the polarization correction module 140, where the polarization analyzer is located downstream with respect to the first and second polarization dependent phase affecting elements 1410 and 1420.

Accordingly, as discussed above, the present disclosure provides a reflective based phase contrast microscope systems, and an inspection system using such phase contrast microscope. The reflective based phase contrast microscope systems utilize an illumination channel, a collection channel, a space variant beam splitting unit and an objective lens arrangement. The space variant beam splitting unit is adapted and positioned to direct illumination from the illumination channel toward the sample via the objective lens, and to direct light collected from the sample toward the collection channel. The space variant beam splitting unit is formed of a pattern of transmitting regions and at least one partly reflecting region configured to maintain annular structure of the illumination pattern associated with phase contrast microscopy and allow transmission of collected light in any spatial form.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. An inspection system comprising a reflective phase contrast microscope system and a sample mount; the reflective phase contrast microscope system comprising an illumination channel, a collection channel, a space variant beam splitting unit and an objective lens arrangement, and is configured for imaging one or more samples positioned on the sample mount;
wherein the space variant beam splitting unit comprises a pattern of transmitting regions and at least one partly reflecting region;
wherein the at least one partly reflecting region has a form that, when reflecting light toward the objective lens or coming from the objective lens, the reflected light pattern forms a ring illumination pattern.

2. The inspection system of claim 1, wherein the partly reflecting regions comprise at least one elliptic segment configured to reflect light toward the objective lens, forming a ring-shaped illumination pattern directed at the objective lens.

3. The inspection system of claim 1, wherein the partly reflecting region has a reflection transmission ratio in a range between 1.5/8.5 and 4/6.

4. The inspection system of claim 1, wherein the collection channel comprises at least one phase plate configured to apply a selected phase variation to light passing therethrough.

5. The inspection system of claim 4, wherein the at least one phase plate comprises a ring-shaped phase affecting region surrounded by transmitting regions, the ring-shaped phase affecting region has geometry and for affecting phase of light associated with the ring illumination pattern.

6. The inspection system of claim 1, wherein the collection channel comprises a variable phase affecting unit operable for selectively tunning phase of light components associated with the ring illumination pattern.

7. The inspection system of claim 6, wherein the variable phase affecting unit comprises two or more controllable polarization dependent phase affecting elements having a ring-shaped phase affecting region surrounded by transmitting regions, and at least one polarization analyzer.

8. The inspection system of claim 7, wherein the two or more controllable polarization dependent phase affecting elements are formed of birefringent materials having a fast axis and a slow axis both perpendicular to direction of transmission of light through the material.

9. A reflective phase contrast microscope system comprising an illumination channel, a collection channel, a space variant beam splitting unit and an objective lens arrangement; the space variant beam splitting unit comprises a pattern of transmitting regions and at least one partly reflecting region;
wherein the at least one partly reflecting region has a form that, when reflecting light toward the objective lens or coming from the objective lens, the reflected light pattern forms a ring illumination pattern.

10. The reflective phase contrast microscope system of claim 9, wherein the partly reflecting regions comprise at least one elliptic segment configured to reflect light toward the objective lens, forming a ring-shaped illumination pattern directed at the objective lens.

11. The reflective phase contrast microscope system of claim 9, wherein the at least one partly reflecting region has a reflection transmission ratio in a range between 1.5/8.5 and 4/6.

12. The reflective phase contrast microscope system of claim 9, wherein the collection channel comprises at least one phase plate configured to apply a selected phase variation to light passing therethrough.

13. The reflective phase contrast microscope system of claim 12, wherein the at least one phase plate comprises a ring-shaped phase affecting region surrounded by transmitting regions, the ring-shaped phase affecting region has geometry and for affecting phase of light associated with the ring illumination pattern.

14. The reflective phase contrast microscope system of claim 9, wherein the collection channel comprises a variable phase affecting unit operable for selectively tunning phase of light components associated with the ring illumination pattern.

15. The reflective phase contrast microscope system of claim 14, wherein the variable phase affecting unit comprises two or more controllable polarization dependent phase affecting elements having a ring-shaped phase affecting region surrounded by transmitting regions, and at least one polarization analyzer.

16. The reflective phase contrast microscope system of claim 15, wherein the two or more controllable polarization dependent phase affecting elements are formed of birefringent materials having a fast axis and a slow axis both perpendicular to direction of transmission of light through the material.

17. The reflective phase contrast microscope system of claim 9, further comprising a polarization correction module configured and operable to provide continuously varying phase and attenuation variation to a selected spatial region of the collection light.

18. The reflective phase contrast microscope system of claim 17, wherein the polarization correction module comprises two or more polarization dependent rotatable phase affecting optical elements, and a polarization analyzer, rotation angle of the phase affecting optical elements provides a selected phase shift and a selected polarization orientation to light components passing through an active phase affecting region of the phase affecting optical elements, the polarization analyzer attenuates output light in accordance with the polarization orientation thereof.

19. The reflective phase contrast microscope system of claim 18, wherein the active phase affecting region of the phase affecting optical elements has an annular shape, being aligned with annular structure of an illumination beam illuminating the sample.

20. The reflective phase contrast microscope system of claim 9, configured for use as a scanning microscope, wherein the illumination channel comprises an annular phase plate and the collection channel comprises an annular collection aperture.
